(19) United States
(12) Patent Application Publication
(10) Pub. No.: US 2022/0112923 A1
(43) Pub. Date: Apr. 14, 2022

(54) WET CLUTCH DEVICE AND WET BRAKE DEVICE

(71) Applicant: SHOWA DENKO K.K., Tokyo (JP)

(72) Inventors: Ryuji MONDEN, Tokyo (JP); Kunio KONDO, Tokyo (JP)

(21) Appl. No.: 17/450,086

(22) Filed: Oct. 6, 2021

(30) Foreign Application Priority Data
Oct. 8, 2020 (JP) 2020-170428

(51) Int. Cl. F16D 13/52; F16D 13/74; F16D 13/64

(52) U.S. Cl. CPC F16D 13/52; F16D 13/648; F16D 13/74

(57) ABSTRACT

The present disclosure provides a device for use as a wet clutch device or a wet brake device that can be used even if friction plates are at high temperatures in the wet clutch-brake. The wet clutch device or the wet brake device includes a disk to which a rotational force is input, and a plate to which the rotational force is transmitted from the disk, wherein the disk and the plate are engageable/separable, and wherein a lubricant composition containing a fullerene at a mass percentage of 0.0001% or more and a mass percentage of less than a saturation solubility of the fullerene is supplied between the disk and the plate.

### CROSS-REFERENCE TO RELATED APPLICATION

The present application is based on and claims priority to Japanese patent application No. 2020-170428 filed on Oct. 8, 2020, with the Japanese Patent Office, the entire contents of which are hereby incorporated by reference.

### BACKGROUND OF THE INVENTION

### 1. Field of the Invention

The disclosures herein relate to a device for use as a wet clutch device and a wet brake device.

### 2. Description of the Related Art

In wet clutch and wet brake devices, various thermal countermeasures have been taken to maintain the performance of the system, such as lowering the friction coefficient of the clutch plates and brake disks when the frictional heat generated causes overheating.

International Publication No. 2017/159305 discloses a wet-type multiple plate clutch that prevents frictional heat from being trapped in the center of the plates and provides uniform temperature distribution of the clutch plates. A wet-type multiple plate clutch includes a drive side tubular member, a plurality of drive side clutch plates fixed in rotation and axially slidable with respect to the drive side tubular member, a driven side tubular member, driven side clutch plates fixed in rotation with respect to the driven side tubular member and axially slidable with respect to the driven side tubular member in an axially alternate manner with respect to the drive side clutch plates, and clutch facings arranged on one of axially opposite surfaces between the drive side clutch plates and the driven side clutch plates, which are axially adjacent with each other, wherein an axially relative movement of the drive side clutch plates and the driven side clutch plates under an outwardly applied force causes said opposite surfaces of the drive side clutch plates and the driven side clutch plates to obtain a clutch engaged condition due to mutual engagements between said opposite surfaces of the drive side clutch plates and the driven side clutch plates by way of the clutch facings while slippage is generated or no slippage is generated. The wet-type multiple plate clutch further includes annular grooves on the surfaces of the clutch plates along substantially an entire circumferential length at parts thereof engaging with the clutch facings. The said parts of the clutch plates are, from respective opposed sides, interposed by insulating materials during the engaged condition of the clutch.

Japanese Patent Application Laid-Open Publication No. 2018-44627 discloses a wet brake that can improve cooling of the plate and disk members. In particular, a wet brake includes a housing, a rotator rotatably disposed in the housing and cooperating with the housing to form therebetween a brake chamber into which cooling oil is forced to flow, a plurality of plates disposed in the brake chamber and axially movably engaged with the housing, a plurality of disks disposed alternatively with the plurality of plates in the brake chamber and axially movably engaged with the rotator, and a piston configured to push the plates and the disks. The housing has a cooling oil inlet that communicates with an inner peripheral region of the brake chamber and a cooling oil outlet that communicates with an outer peripheral region of the brake chamber, and an oil collecting passage is formed adjacent to an open end of the cooling oil outlet on a brake chamber side to communicate with the brake chamber and is continuous circumferentially.

### SUMMARY OF THE INVENTION

As mentioned above, thermal countermeasures have been taken for wet clutch and wet brake devices. However, such countermeasures are designed to prevent the wet clutch and wet brake devices from overheating by devising cooling methods, and are not usable countermeasures at high temperatures.

The object of the present invention is to provide a device for use as a wet clutch device or a wet brake device (hereinafter, both may be collectively referred to as “wet clutch-brake”) that can be used even if friction plates are at high temperatures in the wet clutch-brake.

The present invention provides the following to solve the above problem.

[1] A device for use as a wet clutch device or a wet brake device includes a disk to which a rotational force is input, and a plate to which the rotational force from the disk is transmitted, wherein the disk and the plate are engageable/separable, and wherein a lubricant composition containing a fullerene at a mass percentage of 0.0001% or more and a mass percentage of less than a saturation solubility of the fullerene is supplied between the disk and the plate.

[2] The device according to the above [1], wherein the lubricant composition contains 0.001% by mass or more and 0.01% by mass or less of fullerene.

[3] The device according to the above [1] or [2], wherein the device is of a wet multiple disk type.

[4] The device according to any one of the above [1] to [3], wherein the plate rotates together with the disk.

[5] The device according to any one of the above [1] to [3], wherein the plate is stationary.

The present disclosure provides a device for use as a wet clutch device or a wet brake device that can be used even if friction plates at high temperatures in the wet clutch-brake.

### DESCRIPTION OF THE PREFERRED EMBODIMENTS

Hereinafter, embodiments of the present invention will be described. The following embodiments are described specifically to give a better understanding of the purpose of the invention, and are not intended to limit the invention unless otherwise specified.

(Wet Clutch-Brake)

The wet clutch-brake of the present embodiment includes a disk to which a rotational force is input (hereinafter, it may simply be referred to as a “disk”) and a plate for transmitting the rotational force from the disk (hereinafter, it may simply be referred to as a “plate”), wherein the disk and the plate are engageable/separable, and wherein a lubricant composition containing a fullerene at a mass percentage of 0.0001% or more and a mass percentage of less than a saturation solubility of the fullerene is supplied between the disk and the plate.

When the disk and plate (hereinafter, both are collectively referred to as “friction plates”) are connected in the wet clutch-brake of the present embodiment, the device whose plate rotates together with the disk is referred to as a wet clutch device, and the device whose plate is stationary is referred to as a wet brake device.

When the friction plates are connected to each other, the lubricant composition is squeezed out from between the friction plates, and the friction generated between the friction plates transmits rotational force and also generates heat. Normally, the friction coefficient between friction plates tends to decrease at higher temperatures, but when the lubricant composition contains fullerenes, the decrease in the friction coefficient between friction plates at high temperatures (for examples, 140° C.) can be suppressed.

The suppression of the decrease in the friction coefficient described above can be evaluated using the methods described in the examples below. In other words, the closer the ratio of the friction coefficient at 140° C. to the friction coefficient at 40° C. in a micro clutch test (hereinafter referred to as the “friction coefficient ratio”) is to 0, the more likely the frictional resistance is to decrease at high temperatures; conversely, the closer the friction coefficient ratio is to 1, the more the decrease in the friction coefficient is suppressed.

In contrast, when the friction plates are separated from each other, the lubricant composition is supplied between the friction plates. At this time, if the friction plates are at high temperature, the friction plates are cooled by the lubricant composition. As a thermal countermeasure, a cooling method to circulate the lubricant composition inside of the wet clutch-brake or a cooling method to circulate the lubricant composition not only inside of the wet clutch-brake but also an external radiator is preferably provided. However, in the present embodiment, as mentioned above, the decrease in the friction coefficient between the friction plates at high temperatures is suppressed, and a wider range of heat generation can be tolerable. Therefore, cooling the friction plates is not necessarily conducted, or lesser extent of cooling can be sufficient for cooling the friction plates.

In addition, for similar reasons with respect to the thermal countermeasure by mechanical structure (for example, Patent Document 1), the present embodiment is economically advantageous because the same countermeasure do not have to be conducted or can be conducted to a lesser extent.

In the present embodiment, the effect of heat can be reduced. Therefore, the technique disclosed in the present embodiment can be preferably applied to wet multiple plate clutches and wet multiple plate brakes, where heat tends to be trapped in the center of multiple friction plates. More specific applications include lock-up clutches installed in the torque converters of automatic (AT) vehicles for wet clutch devices, and multiple plate disk brakes of wet brake devices, which apply braking force to the rotating shafts of swivel equipment such as agricultural and construction machinery.

(Lubricant Composition)

The lubricant composition used in the present embodiment may be simply a base oil such as mineral oil or synthetic oil to which fullerene has been added, but in addition, additives commonly used in lubricant compositions for wet clutches and brakes may be added to the extent that the effect of the present embodiment is not impaired. Fullerenes may be added to commercially available lubricant compositions to which appropriate amounts of such additives have been added. Hereinafter, the aforementioned base oils and lubricant compositions to which fullerene has not been added are referred to as “raw oils”.

The lubricant composition used in the present embodiment contains fullerenes. The lower limit of the content of fullerene in the lubricant composition is 0.0001% by mass or more and preferably 0.001% by mass or more from the viewpoint of suppressing the aforementioned decrease in the friction coefficient. From the viewpoint of long-term stability, such as when fullerenes are directly and/or indirectly reacted with oxygen when exposed to the atmosphere, 0.01% by mass or more is more preferably used.

The upper limit of the content of fullerene in the lubricant composition is the saturation solubility or less. From an economic point of view, the upper limit of the content of fullerene in the lubricant composition is preferably 0.1% by mass or less and more preferably 0.01% by mass or less. If the fullerene content exceeds the saturation solubility, fullerene tends to precipitate as agglomerated grains, and the agglomerated grains may cause wear inside the wet clutch-brake.

The value of the saturation solubility measured at room temperature (20° C.) may be used as the upper limit of the content of fullerene, but in consideration of the above, if the temperature range within the wet clutch brake of the present embodiment is known, a value that is a mass percentage of less than the saturation solubility within the temperature range is preferable. If the saturation solubility is unknown, the upper limit of the content of fullerene should be 0.3% by mass, because the saturation solubility of fullerene in lubricants generally used for wet clutches-brakes is about 0.3 to 1% by mass. Any combination of each of the aforementioned upper and lower limits can be used as the range of the content of fullerene.

Various types of fullerenes can be used in the present embodiment. Fullerenes include, for example, C₆₀ and C₇₀, which are relatively easy to obtain, higher fullerenes, or mixtures thereof. Among the fullerenes, C₆₀ and _{C70} are preferably used from the viewpoint of availability and high saturation solubility, and C₆₀ is more preferably used. When a mixture is used, 50% by mass or more of C₆₀ is preferably contained in the mixture.

The above raw oils can be selected according to the application or the like of wet clutch-brakes. In general, lubricants are classified according to their viscosity (kinematic viscosity). For example, a machine oil equivalent to ISO VG32 to 68 can be used for general applications, if gear lubrication is also required, higher viscosity such as ISO VG68 to 320 can be used. If drag torque is to be reduced, or if the product is to be used at high speeds or in cold climates, the lower viscosity ISO VG5 to 10 can be used. As described below in the examples and comparative examples, the addition of fullerene has less effect on viscosity. Therefore, as a guide, a raw oil with a viscosity equivalent to the desired viscosity as a fullerene-containing lubricant composition can be selected.

Examples of the aforementioned additives include friction modifiers, antioxidants, corrosion inhibitors, viscosity index improvers, extreme pressure additives, detergent-dispersants, pour point depressants, antifoaming agents, solid lubricants, oiliness improvers, rust inhibitor additives, anti-emulsifiers, hydrolysis inhibitors, and the like. One of these additives may be used alone, or two or more may be used in combination. In general, friction modifiers are often added to lubricant compositions for a wet clutch-brake.

Examples of friction modifiers include phosphate esters such as acidic phosphate ester amine salts, and the like; fatty acid esters such as oleic triglyceride, stearyl alcohol, and the like; ether compounds of higher alcohols with eight or more carbons and glycerin, oleic acid, oleic acid diethanolamide, and the like. Examples of antioxidants include compounds such as amines, phenols, and the like. Examples of corrosion inhibitors include benzotriazole, alkenylsuccinate, and the like. Examples of viscosity index improvers include polymethacrylate, olefin copolymers, and the like. Examples of extreme pressure additives include sulfated oils and fats, sulfated olefins, sulfides, phosphate esters, phosphite esters, thiophosphate esters, and the like. Examples of detergent-dispersants include metal detergent-dispersants, ashless dispersants, and the like. Examples of metal detergent-dispersants include alkali earth metal sulfonates, alkali earth metal phenates, and the like. Examples of ashless dispersants include alkenylsuccinic acid imides, alkenylsuccinic acid esters, amides of long-chain fatty acids with polyamines (amino amide type), and the like. Examples of pour point depressants include polymethacrylate and the like. Examples of antifoaming agents include silicone compounds, ester-based antifoaming agents, and the like.

Although the preferred embodiments of the present invention have been described in detail above, the present invention is not limited to the specific embodiments, and various variations or changes can be made within the scope of the present invention as described in the claims.

### EXAMPLES

Hereinafter, the present invention will be described in more detail with reference to Examples and Comparative Examples, but the present invention is not limited to the following Examples.

(Measurement of Friction Coefficient Ratio)

The friction coefficients of the sample oils were measured using the friction test method by the micro clutch testing machine (JCMAS P 047:4) in accordance with Machinery-Test Method for Friction Characteristics (JCMAS P 047:2004) established by the

Japan Construction Mechanization Association/Hydraulic Fluids for Construction. Where, the friction test conditions were as follows.

[Test Conditions]
Sample oil: Lubricant composition obtained from each Example and Comparison Example
Clutch disk facing material: SD1795-S
Plate material: SS400
Oil temperature: 40° C., 140° C.
Contact pressure: 392 kPa
Sliding speed: 30 mm/s
Testing time: 5 min

The friction coefficient ratio obtained above was obtained by dividing the friction coefficient measured at an oil temperature of 140° C. by the friction coefficient measured at an oil temperature of 40° C.

(Measurement of Kinematic Viscosity)

Twenty milliliters of the lubricant compositions produced in Examples 1 to 8, Comparative Example 2, and Comparative Example 4 were used as samples and measured using a Cannon-Fenske viscometer (Fully automatic kinematic viscometer, CAV-2100 type, manufactured by Cannon) by the method in accordance with JIS K2283:2000. The sample temperature was set to 40° C. or 140° C., and the average value of three repeated measurements at each temperature was used as the kinematic viscosity value.

### Examples 1 to 4, Comparative Example 1

A mineral oil (Dianafresia P-46 manufactured by Idemitsu Kosan) was used as the raw oil, and fullerene (nanom mix ST, manufactured by Frontier Carbon Corporation) was added to the oil so as to contain the content of fullerene of 1% by mass (Comparative Example 1), 0.1% by mass (Example 1), 0.01% by mass (Example 2), 0.001% by mass (Example 3), and 0.0001% by mass (Example 4) to prepare lubricant compositions. Insoluble part of fullerene was observed in the lubricant composition of Comparative Example 1 in which fullerene was added at 1% by mass. Therefore, the friction coefficient and kinematic viscosity were measured for each lubricant composition except Comparative Example 1. The results are indicated in Table 1.

### Comparative Example 2

The operation and measurement were performed in the same manner as in Example 1, except that a mineral oil (Dianafresia P-46, manufactured by

Idemitsu Kosan) was used as the lubricant composition. The result is indicated in Table 1.

### Examples 5 to 8, Comparative Example 3

The operations and measurements were performed in the same manner as in Examples 1 to 4 and Comparative Example 1, except that a commercial hydraulic oil (DAPHNE SuperHydro 46HN, manufactured by Idemitsu Kosan) containing an additive was used instead of the mineral oil. Insoluble part of fullerene was observed in the lubricant composition of Comparative Example 3 in which fullerene was added at 1% by mass. Therefore, the friction coefficient and kinematic viscosity were measured for each lubricant composition except Comparative Example 3. The results are indicated in Table 1.

### Comparative Example 4

The operation and measurement were performed in the same manner as in Comparative

Example 2, except that a commercial hydraulic oil (DAPHNE SuperHydro 46HN, manufactured by Idemitsu Kosan) was used instead of the mineral oil. The result is indicated in Table 1.

TABLE 1

| | | Content of | Friction | | Friction | Kinematic viscosity | |
|---|---|---|---|---|---|---|---|
| | | fullerene | coefficient | | coefficient | (mm²/s) | |
| | Raw oil | (% by mass) | 40° C. | 140° C. | ratio | 40° C. | 140° C. |
| Comparative | Mineral oil | 1 | Not measured due to insoluble part of fullerene | | | | |
| Example 1 | | | | | | | |
| Example 1 | | 0.1 | 0.176 | 0.146 | 0.83 | 46.42 | 3.43 |
| Example 2 | | 0.01 | 0.171 | 0.147 | 0.86 | 46.26 | 3.44 |
| Example 3 | | 0.001 | 0.162 | 0.148 | 0.91 | 46.07 | 3.44 |
| Example 4 | | 0.0001 | 0.162 | 0.126 | 0.78 | 46.05 | 3.43 |
| Comparative | | 0 | 0.162 | 0.119 | 0.73 | 46.04 | 3.43 |
| Example 2 | | | | | | | |
| Comparative | Commercial | 1 | Not measured due to insoluble part of fullerene | | | | |
| Example 3 | hydraulic oil | | | | | | |
| Example 5 | | 0.1 | 0.155 | 0.132 | 0.85 | 47.52 | 3.43 |
| Example 6 | | 0.01 | 0.150 | 0.133 | 0.89 | 47.49 | 3.44 |
| Example 7 | | 0.001 | 0.148 | 0.137 | 0.93 | 47.46 | 3.44 |
| Example 8 | | 0.0001 | 0.135 | 0.101 | 0.75 | 47.45 | 3.44 |
| Comparative | | 0 | 0.133 | 0.093 | 0.70 | 47.44 | 3.43 |
| Example 4 | | | | | | | |

Each Example maintains a higher friction coefficient at 140° C. than Comparative Examples 2 and 4, resulting in a higher friction coefficient ratio. In particular, a sufficiently high friction coefficient ratio was obtained when the content of fullerene was 0.001% by mass or higher, and the friction coefficient ratio did not change significantly even when the content of fullerene was further increased. In addition, when Examples 1 to 4 are compared with Examples 5 to 8, it can be seen that these Examples indicate similar tendencies regardless of the types of the raw oils and the presence or absence of the additives. In each of Examples and Comparative examples where the friction coefficient was measured, no wear marks were observed on the friction plates before and after the measurement.

In addition, it can be seen that fullerene has almost no effect on kinematic viscosity from the comparison between Comparative Example 2 and Examples 1 to 4, and between Comparative Example 4 and Examples 5 to 8.

The present invention can be used in machinery and equipment such as vehicles, agricultural machinery, and construction machinery that use wet clutches and wet brakes.

What is claimed is:

1. A device for use as a wet clutch device or a wet brake device, comprising:
a disk to which a rotational force is input; and
a plate to which the rotational force from the disk is transmitted;
wherein the disk and the plate are engageable/separable, and
wherein a lubricant composition containing a fullerene at a mass percentage of 0.0001% or more and a mass percentage of less than a saturation solubility of the fullerene is supplied between the disk and the plate.

2. The device according to claim 1, wherein the lubricant composition contains 0.001% by mass or more and 0.01% by mass or less of the fullerene.

3. The device according to claim 1, wherein the device includes a plurality of wet disks.

4. The device according to claim 2, wherein the device includes a plurality of wet disks.

5. The device according to claim 1, wherein the plate rotates together with the disk.

6. The device according to claim 2, wherein the plate rotates together with the disk.

7. The device according to claim 3, wherein the plate rotates together with the disk.

8. The device according to claim 1, wherein the plate is stationary.

9. The device according to claim 2, wherein the plate is stationary.

10. The device according to claim 3, wherein the plate is stationary.
